(19) United States
(12) Patent Application Publication
(10) Pub. No.: US 2006/0095220 A1
(43) Pub. Date: May 4, 2006

(54) Crosstalk reduction digital systems

(75) Inventors: Jiri Vrba, Coquitlam (CA); Peter Spear, Burnaby (CA); Jack McCubbin, Port Coquitlam (CA); Richard Willis, Port Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: VSM MedTech Systems Inc., Coquitlam (CA)

(21) Appl. No.: 10/977,016

(22) Filed: Nov. 1, 2004

(51) Int. Cl. G01D 18/00

(52) U.S. Cl. 702/104

(57) ABSTRACT

The invention provides a method of compensating for crosstalk between electromagnetic sensors in an array, each sensor having a flux transformer with a current therein which does not vary smoothly with an applied magnetic field, each sensor configured to produce an output signal comprising a stepwise varying component and a finely varying component. The method comprises, for each sensor to be compensated, applying a crosstalk compensation function to the output signal of the sensor to be compensated, the crosstalk compensation function based at least in part on at least one of the stepwise and the finely varying components of at least one other of the sensors in the array.

### TECHNICAL FIELD

The invention relates to reducing crosstalk between electromagnetic sensors. The invention has particular application to sensors in which output signals have both finely varying (analog) and stepwise varying (digital) components. Some embodiments of the invention relate to reducing crosstalk between sensors which incorporate superconducting quantum interference devices (SQUIDs) having flux transformers that are inductively coupled to one another and are operated with digital feedback loops.

### BACKGROUND

A SQUID can be used as an extremely sensitive detector of magnetic fields. SQUIDs are used in many fields from geomagnetic prospecting to detecting biomagnetic fields. In some applications it is desirable to provide multiple SQUID detectors which are near to one another.

One type of SQUID sensor includes a superconducting flux transformer, a superconducting ring with Josephson junctions, and circuitry for coupling the sensor to room temperature electronics. When the SQUID sensor detects a magnetic field, current flows in the flux transformer. The current causes the flux transformer to produce its own magnetic field. When the flux transformers of two or more SQUID sensors are located near to one another, each of the SQUID sensors may detect the magnetic fields of other nearby flux transformers of one or more other nearby SQUID sensors in addition to the magnetic signal of interest. The detection of the magnetic fields generated by the nearby flux transformers is called crosstalk.

Magnetoencephalography (MEG) is a method of imaging a subject's brain by detecting magnetic fields generated by electric currents within the brain. MEG machines typically include arrays of SQUID detectors to detect and measure the minute biomagnetic fields that are of interest. Such an array is referred to herein as a multi-channel SQUID system, and the output of each of the sensors is referred to as a channel. The trend in MEG imaging is to provide larger numbers of SQUID sensors. This permits the sources of magnetic fields to be located more precisely. However, as the number of SQUID sensors is increased, the flux transformers of the SQUID sensors become closer to the flux transformers of neighboring SQUID sensors. This increases crosstalk between neighboring SQUID sensors in comparison to situations in which SQUID sensors are spaced farther apart from one another.

SQUID sensors exhibit a multivalued transfer function between applied magnetic field and the resulting output voltage. For this reason, SQUIDs are usually operated as null detectors in some type of feedback loop arrangement. SQUID feedback loops can be analog or digital.

In SQUID sensor systems with analog feedback loops, the inductive crosstalk between flux transformers can be reduced or eliminated by providing feedback directly into the flux transformer. The feedback is controlled to prevent current from flowing in the flux transformer. Such a method for crosstalk elimination in a SQUID system with an analog feedback loop was described by: Ter Brake, H. J. M., Fleuren, F. H., Ulfman, J. A. and Flokstra, J., Elimination of flux transformer crosstalk in multichannel SQUID magnetometers, Cryogenics, 26, p. 670, 1986 (referred to herein as “Ter Brake et al.”).

In SQUID sensor systems with digital feedback loops the output signal includes both finely varying (analog) and stepwise varying (digital) components. Compensating for or eliminating crosstalk in such systems is complicated because crosstalk is a function of both the digital and analog components of the signal. The inventors have determined that there is a need for a way to reduce and compensate for the effect of crosstalk in systems having multiple sensors which provide output signals having a finely varying part and a stepwise varying part.

### SUMMARY OF THE INVENTION

One aspect of the invention provides a method for crosstalk reduction and compensation in SQUID systems having digital feedback loops where the finely varying (analog) and stepwise varying (digital) components of an output signal exhibit crosstalk with different magnitudes. The method reduces such crosstalk by applying a crosstalk correction function to the output signal to yield a corrected output signal. The crosstalk correction function is based at least in part on at least one of the stepwise and finely vary components of at least one of the other sensors in the array.

Another aspect of the invention provides an apparatus for compensating for crosstalk between electromagnetic sensors in an array. Each sensor has a flux transformer with a current therein which does not vary smoothly with an applied magnetic field, and is configured to produce an output signal comprising a stepwise varying component and a finely varying component. The apparatus comprises means for applying a crosstalk compensation function to the output signal of each sensor to be compensated. The crosstalk compensation function is based at least in part on at least one of the stepwise and the finely varying components of at least one other of the sensors in the array.

Another aspect of the invention provides a computer program product comprising a medium carrying computer readable instructions which, when executed by a processor, cause the processor to execute a method of compensating for crosstalk between electromagnetic sensors in an array. Each sensor has a flux transformer with a current therein which does not vary smoothly with an applied magnetic field, and is configured to produce an output signal comprising a stepwise varying component and a finely varying component. The method comprises, for each sensor to be compensated, applying a crosstalk compensation function to the output signal of the sensor to be compensated. The crosstalk compensation function is based at least in part on at least one of the stepwise and the finely varying components of at least one other of the sensors in the array.

Another aspect of the invention provides an apparatus comprising a sensor array for measuring magnetic fields. The sensor array comprises a plurality of sensors, each sensor comprising a SQUID inductively coupled to a flux transformer coupling coil and a feedback coil. A first product of a mutual inductance between the flux transformer coupling coil and the SQUID and a mutual inductance between the feedback coil and the SQUID is substantially equal to a second product of a mutual inductance between the feedback coil and the flux transformer coupling coil and an inductance of the SQUID.

Further aspects of the invention and features of specific embodiments of the invention are described below.

### BRIEF DESCRIPTION OF THE DRAWINGS

In drawings which illustrate non-limiting embodiments of the invention,

FIG. 1 is a schematic diagram of a SQUID sensor having a flux transformer and an analog feedback loop, according to the prior art;

FIG. 2 is a schematic diagram of a SQUID sensor having a flux transformer and a digital feedback loop, according to the prior art;

FIG. 3 is a schematic diagram of a DC SQUID transfer function indicating a periodicity of one flux quantum (1 Φ₀), according to the prior art;

FIG. 4A is a plot showing the variation with time of an example input signal B measured by the SQUID sensor of FIG. 2;

FIGS. 4B and 4C are schematic diagrams of the analog and digital parts, respectively, of the output signal of the SQUID sensor of FIG. 2 in response to the input signal B of FIG. 4A;

FIG. 5 is a schematic diagram illustrating two adjacent SQUID sensors;

FIGS. 6A and 6B are schematic diagrams illustrating SQUID sensors with alternative circuits for supplying feedback signals;

FIG. 7 is a schematic diagram of a SQUID sensor and flux transformer with feedback supplied to the SQUID ring;

FIG. 8 shows plots of feedback current, flux transformer current, and digital counter values as a function of applied field for the SQUID sensor of FIG. 7;

FIG. 9 is a schematic diagram of a SQUID sensor and flux transformer with feedback supplied to the flux transformer;

FIG. 10 shows plots of feedback current, flux transformer current, and digital counter as a function of applied field for the SQUID sensor of FIG. 9;

FIG. 11 shows an example of crosstalk correction for two MEG channels wherein the crosstalk coefficients and digital and analog fractions were determined by computation;

FIG. 12 is a schematic diagram of a SQUID sensor and flux transformer with feedback supplied to the SQUID ring, wherein an external signal (iₑ) is applied from within SQUID electronics directly to the feedback loop to facilitate measurement of the crosstalk coefficients;

FIG. 13 indicates the behavior of currents in the circuit of FIG. 12 and the digital counter in the vicinity of flux transitions for cases of zero applied field (a-d) and zero external current (e-h), where the SQUID was cooled down in zero applied field;

FIG. 14 shows an example of a graph which may be used for experimental determination of the digital fraction f_{D};

FIG. 15 is a block diagram of a magnetic imaging apparatus according to an embodiment of the invention;

FIGS. 16 and 17 respectively show data flows which may be implemented for making analog and digital crosstalk corrections to signals from a sensor in an array of sensors; and,

FIG. 18 illustrates example structures for some of the arrays of FIGS. 16 and 17.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

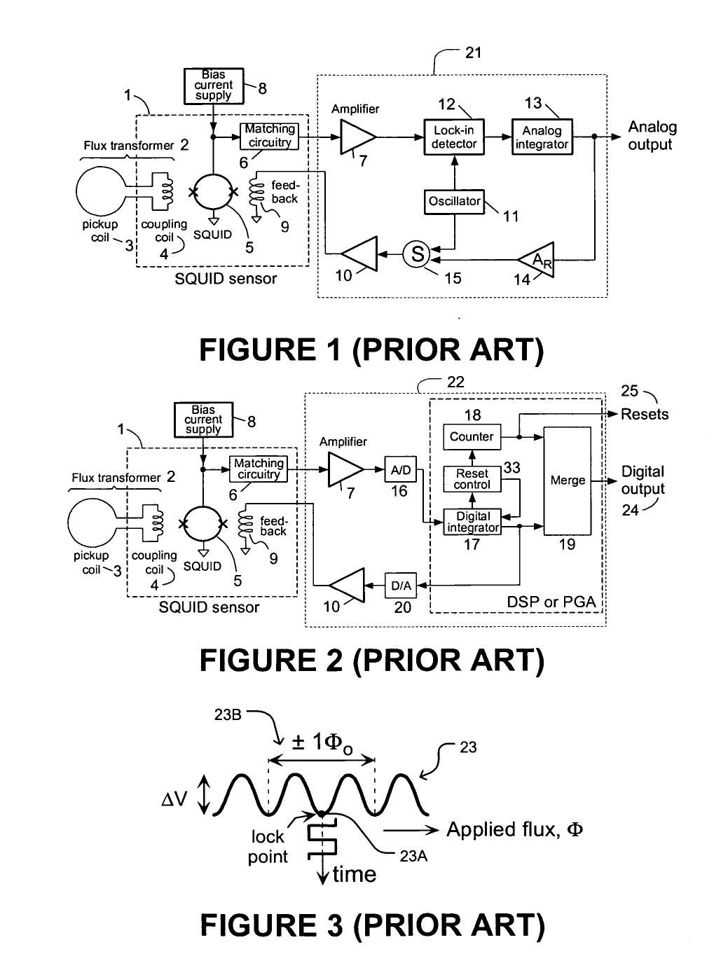

FIG. 1 shows a SQUID sensor 1 and its electronics with an analog feedback loop 21, according to the prior art (e.g., Clarke, J. (1996) SQUID Fundamentals, in H. Weinstock (ed.), SQUID Sensors: Fundamentals, Fabrication and Applications, NATO ASI Series E: Applied Sciences, Vol. 329, Kluwer Academic Publishers, Dordrecht, 1-62). SQUID sensor 1 comprises a superconducting ring 5 having one or two Josephson junctions (two Josephson junctions are shown in FIG. 1). SQUID sensor 1 may be biased by dc or rf current. In the FIG. 1 example, a dc bias current supply 8 is provided. SQUID sensor 1 is coupled to a magnetic field to be measured by a superconducting flux transformer 2. Superconducting flux transformer 2 comprises a pickup coil 3 and a coupling coil 4. An oscillator 11 provides modulation to SQUID sensor 1 through a summing circuit 15, an amplifier 10, and a feedback coil 9. The modulation, feedback signal, and flux transformer output are combined in superconducting ring 5 of SQUID sensor 1, passed through matching circuitry 6, amplified by an amplifier 7, and demodulated in a lock-in detector 12. The demodulated output is integrated by an integrator 13, amplified by an amplifier 14, and fed back as a flux to SQUID sensor 1. The flux fed back to SQUID sensor 1 maintains the total flux input to ring 5 close to zero. The output of integrator 13 is proportional to the magnetic field applied to pickup coil 3. This output is a signal which provides an analog measurement of the applied field.

Analog feedback loop 21 is not always adequate for the operation of SQUID sensor 1. In addition to the field to be measured, SQUID sensor 1 is typically also exposed to environmental noise which increases demand on the electronics coupled to SQUID sensor 1. For satisfactory detection of magnetic fields, SQUID sensor 1 must exhibit large dynamic range, good linearity, and satisfactory slew rates. In a multi-channel system, such as an MEG system having an array of SQUID sensors, the SQUID sensors must provide good inter-channel matching. The operating characteristics of a SQUID sensor depend on factors such as the design of pickup coil 3, the design of flux transformer 2 and on whether the system is operated in a shielded or unshielded environment. It has been found that satisfying foregoing requirements can be facilitated by providing a digital feedback loop 22, as shown in FIG. 2, in place of analog feedback loop 21.

In the FIG. 2 example, SQUID sensor 1, flux transformer 2, and bias current supply 8 are the same as in the FIG. 1 example. However, digital feedback loop 22 includes an analog to digital converter 16 for digitizing the amplified signal from SQUID sensor 1, a digital integrator 17 for digitally integrating the signal, and a digital to analog converter 20 for providing the feedback signal back to SQUID sensor 1.

For clarity, FIGS. 1 and 2 do not show separately various signal processing elements such as filters and amplifiers which may be provided to remove noise of various types such as 50 Hz or 60 Hz power line noise, 1/f noise and the like from the signal.

Digital feedback loop 22 utilizes the flux periodicity of the SQUID transfer function to extend the dynamic range of SQUID sensor 1. A periodic SQUID transfer function 23 is shown in FIG. 3 (this transfer function is sinusoidal for a DC SQUID, as shown, or it can be triangular for RF SQUID, not shown). Feedback supplied by digital feedback loop 22 maintains flux through superconducting ring 5 constant (“locked”) at a certain point 23A along transfer function 23. The flux remains locked in the vicinity of point 23A while the applied field is within a threshold range 23B of the point 23A. In the illustrated embodiment, range 23B is ±1 Φ₀.

When range 23B is exceeded, electronics in digital feedback loop 22 cause a “reset” to occur. The effect of the reset is that the flux through ring 5 is allowed to vary (“released”), such that the locking point is shifted by one or more Φ₀ along the transfer function. The release of the flux lock point is controlled by reset control 33 in the example of FIG. 2. The flux transitions along the transfer function are counted by counter 18 and merged with the signal from digital integrator 17 at merge 19 to form a digital output 24 which is proportional to the field applied to pickup coil 3. The digital circuitry in FIG. 2 can also be implemented in a digital signal processor (DSP), a programmable gate array (PGA) or the like. As one skilled in the art will appreciate, although the examples described herein refer to resets occurring when the field changes by one flux quantum, the number of flux quanta required to trigger the reset may be one half or two or more, depending on the dynamic range and resolution desired.

Output from digital feedback loop 22 also includes a reset output 25, which indicates when resets have occurred. Reset output 25 carries information regarding the transitions along SQUID transfer function 23. Reset output 25 describes how the locking point on the transfer function has changed: e.g. a time at which the locking point change occurred and which direction along the transfer function the change occurred. Reset output 25 may also indicate as well as the number of flux quanta let into or expelled from the SQUID during the resets. The combination of digital output 24 and reset output 25 permits unique separation of the signal S at output 24 of SQUID sensor 1 into an analog or finely varying component, A, (which is the output of digital integrator 17) and a digital or stepwise varying component, D, (which is the output of counter 18).

In an example embodiment of the invention the magnitude of the feedback current is controlled by a digital signal processor (DSP) and/or programmable gate array (PGA). Digital feedback loop 22 linearizes the output of SQUID sensor 1 and provides a 20 bit output having a range corresponding to a flux change of 1 flux quantum. In this embodiment, counter 18 measures the number of flux quanta with ±11 bit range. As a result, the example system provides an overall SQUID sensor dynamic range of 32 bits. This gives a maximum signal amplitude of approximately ±600 nT while retaining least significant bit (LSB) resolution of approximately 0.3 fT over the full range. With such a wide dynamic range (192 dB), full resolution is maintained without the need for range switching.

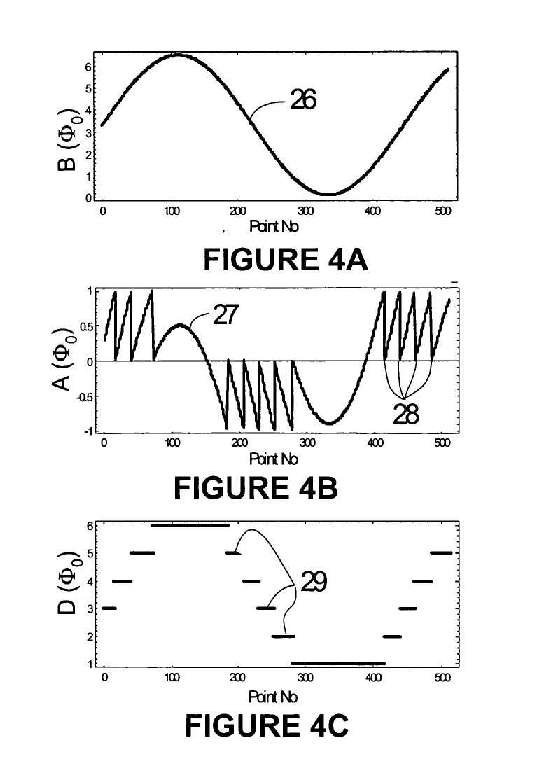

FIGS. 4A-4C graphically illustrate separation of the measured signal S into analog A and digital D components. A sinusoidally varying applied field B is shown as input signal 26 in FIG. 4A with an amplitude corresponding to several flux quanta. The analog component A of signal S is shown as signal 27 in FIG. 4B, and has an amplitude in the range of ±1 Φ₀. Transitions 28 in signal 27 occur where the flux through ring 5 is released and the locking point is shifted by Φ₀ along the transfer function. The corresponding digital D component is shown as a counter signal 29 in FIG. 4C. Signal 29 indicates by how many flux quanta the locking point has been shifted. Addition of the signals 27 and 29 results in the signal (S=A+D) from SQUID sensor 1. Signal S should be, in the absence of crosstalk, exactly proportional to the applied field B.

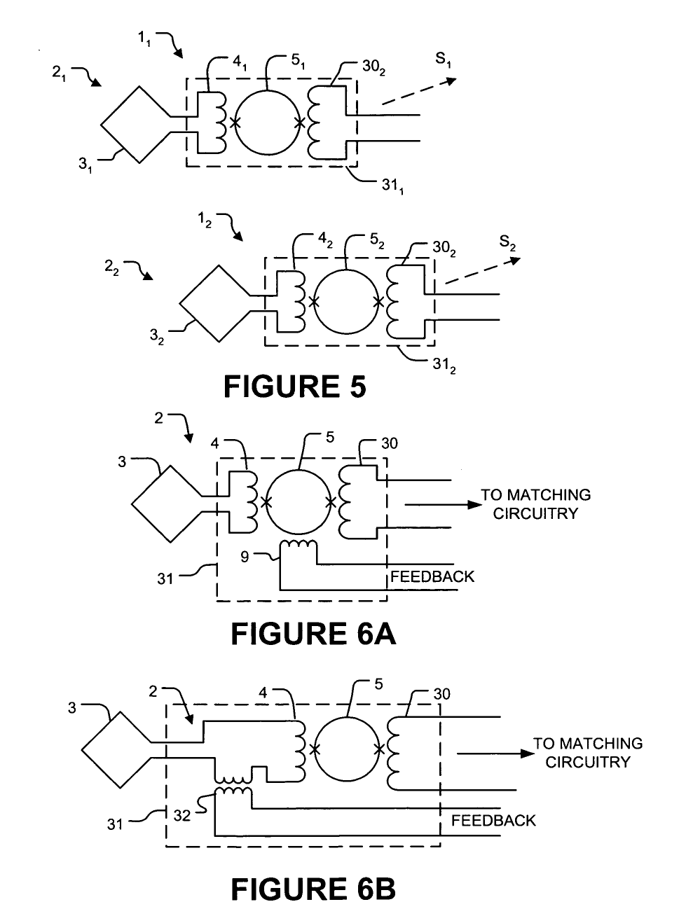

FIG. 5 shows a pair of adjacent SQUID sensors 1 and associated flux transformers 2 (individually labelled 1₁, 1₂, 2₁, and 2₂). Each flux transformer 2 has a pickup coil 3 having an area A, and a coupling coil 4 which couples to superconducting ring 5. Each ring 5 is coupled to matching circuitry (reference numeral 6 in FIGS. 1 and 2), by output coil 30. Feedback coils (reference numeral 9 in FIGS. 1 and 2) are not shown in FIG. 5 for ease of illustration. Output coils 30, rings 5 and coupling coils 4 are typically enclosed within magnetic shields 31. Each of SQUID sensors 1 produces, after processing by suitable signal conditioning electronics, a corresponding output signal S1, with i∈{1,2}. The output signals Sᵢ, correspond to the magnetic fields applied to pickup coils 3ᵢ.

When pickup coil 3₁ is exposed to a magnetic field B, the introduction of the magnetic field induces an electric current i₁ in flux transformer 2₁. This electric current in flux transformer 2₁ generates a magnetic field which is inductively coupled to pickup coil 3₂ of flux transformer 2₂ to produce an output signal S₂. Even though there may be no external field applied to the pickup coil 3₂ directly, output signal S₂ is not zero, and is a manifestation of crosstalk between the sensors 1₁ and 1₂. When properly calibrated, each output signal Sᵢ is a measure of the magnetic field Bᵢ apparent at the associated pickup coil 3ᵢ. The apparent magnetic field is the sum of the applied magnetic field B and crosstalk from other sensors. The magnitude of the crosstalk included in output signal S₂ is given by:
S₂=ξ₂₁S₁ (1)
were ξ₂₁ is a crosstalk coefficient which is determined by the geometrical relationship between sensors 1₁ and 1₂. The second index in ξ₂₁ indicates the source of the crosstalk and the first index indicates the recipient of the crosstalk. ξ₂₁ is given by:

$${ξ}_{21} = \frac{{M}_{12} {β}_{1}}{{A}_{2}} \\ \qquad ( 2 )$$

where:
M₁₂ is the mutual inductance of pickup coils 3₁ and 3₂;
β₁ is the factor relating the flux transformer current to the applied magnetic field B (i.e. i₁=β₁B₁); and,
A₂ is the effective area of pickup coil 3₂ taking into account the number of turns of pickup coil 3₂ (for example, if pickup coil 3₂ is circular of radius r and has N turns then A₂=πr²N).

The inventors have determined that in typical cases the crosstalk factor ξ₂₁ increases rapidly as the distances between pickup coils 3 decrease. For example, for a particular geometry of radial gradiometer pickup coils used in an MEG system, ξ₂₁ ∝d^{-3.6}, where d is a distance between pickup coils.

How the flux transformer current i₁ varies in response to the magnetic field at pickup coil 3₁ depends upon how sensor 1₁ is controlled. If sensor 1₁ is operated in an analog mode (as in FIG. 1) the magnitude of i₁ varies smoothly with the flux passing through pickup loop 3₁. In this case there exists a simple relationship between output signals Sₘ of an array of M SQUID sensors 1ₘ and the fields Bₘ applied to their respective pickup coils 3ₘ. In a multi-channel SQUID system, the crosstalk between channels can be characterized by:

$${S}_{m} ( t ) = {B}_{m} ( t ) + {\sum }_{j = 1 , j \neq m}^{M} {ξ}_{mj} {S}_{j} ( t ) \qquad ( 3 )$$

where:
Sₘ(t) is the signal detected at the m^{th} sensor;
m and j are indices which range over the sensors in the array;
M is the number of sensors;
Bₘ(t) is the true magnitude of the applied magnetic field at the m^{th} sensor; and,
Sⱼ(t) is the signal detected at the j^{th} sensor.

In this analog example, it is straightforward to correct for the crosstalk and compute the true field magnitudes by performing a simple matrix multiplication as follows:
B=ζS (4)
where ζ is a crosstalk correction matrix given by:

$$ς = ( \begin{matrix}1 & - {ξ}_{12} & … & - {ξ}_{1 M} \\ - {ξ}_{21} & 1 & … & - {ξ}_{2 M} \\ … & … & 1 & … \\ - {ξ}_{M 1} & - {ξ}_{M 2} & … & 1\end{matrix} ) \qquad ( 5 )$$

and B and S are vectors of magnetic fields and sensor outputs, respectively. Each vector B and S has M components.

In analog systems, as shown in FIGS. 1 and 5, the SQUID's superconducting ring 5 acts as a null detector (feedback is applied directly to ring 5 through feedback coil 9). In such systems the current in the flux transformer varies with time and causes crosstalk, as described above.

It is not mandatory for the feedback to be supplied to superconducting ring 5. The feedback signal may be supplied in a number of alternative ways. For example, feedback can be supplied to null the current in flux transformer 2. In this case, the feedback signal can be supplied directly to flux transformer 2. When operated with an analog feedback loop, such a configuration will cause the flux transformer current i to be zero and there will be no inductive crosstalk between the flux transformers, as described by Ter Brake et al.

FIGS. 6A and 6B illustrate alternative constructions for coupling a feedback signal either into ring 5 or flux transformer 2, respectively. In FIG. 6A feedback coil 9 is coupled to SQUID ring 5 (output coil 30 again represents input into the matching circuitry 6 of FIG. 1). In FIG. 6B, a feedback coil 32 is coupled to the flux transformer 2 and causes the flux transformer current i to be zero when operating in analog mode.

For digital SQUID systems, such as the example illustrated in FIG. 2, the situation is more complicated. A consequence of the operation of digital feedback loop 22 is that the current i in flux transformer 2 is not a smoothly varying function of the applied field. In addition, the inventors have determined that the analog A and digital D parts of the signal S, as shown in FIG. 4, will cause crosstalk with different crosstalk coefficients. Therefore, crosstalk between adjacent flux transformers 2 cannot be compensated for by way of Equation (4).

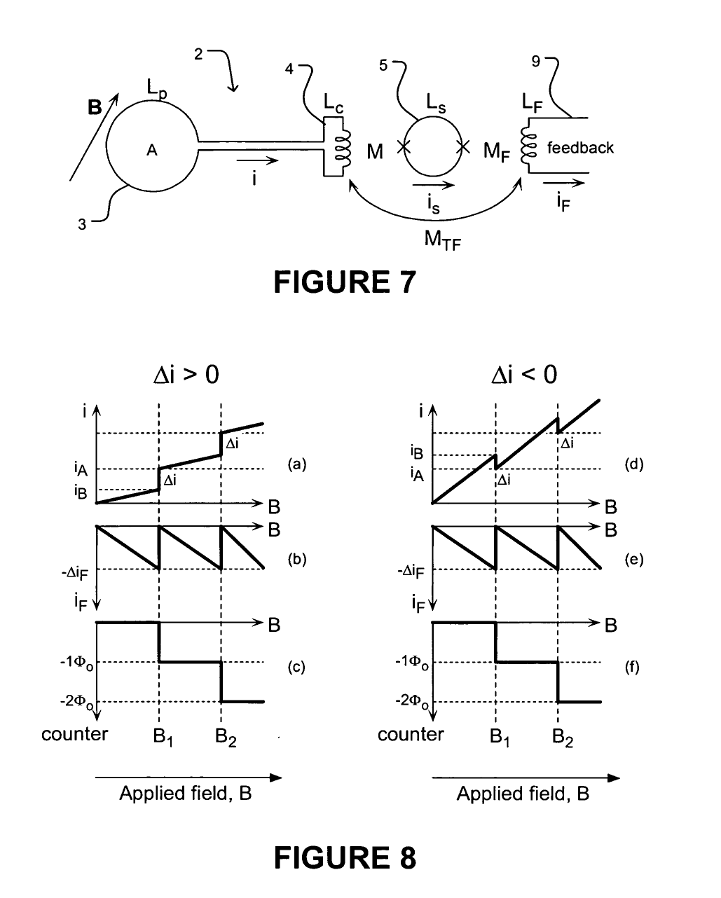

FIG. 7 schematically illustrates various circuit parameters of a SQUID system where feedback is applied to ring 5, as in FIG. 2 or 6A, and the feedback is supplied by a digital feedback loop (such as digital feedback loop 22 of FIG. 2). Operation of one of SQUID sensors 1 can be characterized by the following equations:
Φ_{fix}+BA=L_{FT}i+Miₛ+M_{TF}+i_{F} (6)
and
nΦ₀=Mi+Lₛiₛ+M_{F}i_{F} (7)
where:
Φ_{fix} is a constant representing the flux applied to flux transformer 2 due to flux trapped in ring 5 when SQUID sensor 1 was cooled to superconducting temperatures (if SQUID sensor 1 was cooled to superconducting temperatures in zero field, Φ_{fix}=0);
Φ₀ denotes one flux quantum;
n is the number of flux quanta trapped in ring 5 when SQUID sensor 1 was cooled to superconducting temperatures (if SQUID sensor 1 was cooled to superconducting temperatures in zero field, n=0);
B is the applied magnetic field;
M is the mutual inductance between coupling coil 4 and ring 5;
M_{F} is the mutual inductance between feedback coil 9 and ring 5;
M_{TF} is the mutual inductance between feedback coil 9 and coupling coil 4;
A is the area of pickup coil 3 multiplied by its number of turns;
i is the current in flux transformer 2;
iₛ is the current in ring 5;
Lₛ is the inductance of ring 5;
i_{F} is the feedback current; and,
L_{FT} is the sum of the inductances L_{P} of pickup coil 3 and L_{C} of coupling coil 4, as well as the lead inductance of flux transformer 2.

Equations (6) and (7) can be solved for flux transformer and feedback currents i and i_{F}, respectively. The changes of these currents during the SQUID reset, are obtained as:

$$\begin{matrix}Δ i = \frac{{Φ}_{0}}{{L}_{s}} \frac{{M}_{F} M - {M}_{TF} {L}_{s}}{{L}_{FT} {M}_{F} - {M}_{TF} M} \\ and & ( 8 ) \\ Δ {i}_{F} = \frac{{Φ}_{0}}{{L}_{s}} \frac{{L}_{FT} {L}_{s} - {M}^{2}}{{L}_{FT} {M}_{F} - {M}_{TF} M} & ( 9 )\end{matrix}$$

where Δi is the discrete flux transformer current change during the reset, and Δi_{F} is the feedback current change during the reset. All other parameters are the same as in equations (6) and (7). Equations (8) and (9) respectively indicate the changes in the magnitudes of the current in flux transformer 2 and the feedback current which occurs when the applied field magnitude reaches a level at which the digital feedback loop is reset. At this level the feedback loop opens and one (or more) flux quanta are admitted or expelled from the SQUID ring 5 and the feedback loop lock is reestablished. These events are associated with discontinuous change of flux transformer and feedback currents i and i_{F}, respectively. Depending on the magnitudes of various inductances and mutual inductances, the flux transformer current step Δi which occurs on a reset induced by an increasing field may be either positive or negative.

FIG. 8 shows example graphs of flux transformer current i, feedback current i_{F}, and the counter value (18 in FIG. 2), which represents the digital component D of output signal S, as a function of applied field B, for a simplified example where the applied magnetic field is a linear ramp starting from B=0. Graphs (a)-(c) illustrate an example where the flux transformer current step Δi is positive and graphs (d)-(f) illustrate an example where the flux transformer current step Δi is negative. The electronic resets and transitions along the SQUID transfer functions occur at applied fields B₁ and B₂ in FIG. 8. At these field values the feedback current changes from its maximum absolute value to zero, and the flux transformer current jumps by the amount Δi, as given by Equation (8). The flux transformer current just before the first reset, i_{B}, and the flux transformer current just after the first reset, i_{A}, can be computed from Equations (6) and (7) as:

$$\begin{matrix}{i}_{B} = \frac{{M}_{F}}{M} Δ {i}_{F} \\ and & ( 10 ) \\ {i}_{A} = \frac{{Φ}_{0}}{M} & ( 11 )\end{matrix}$$

Currents i_{B} and i_{A} for Δi>0 and Δi<0 are shown in graphs (a) and (d), respectively, in FIG. 8. At the values B₁ and B₂ the applied field is just sufficient to cause another quantum of flux to enter superconducting ring 5. At these points the feedback loop is opened and a reset happens. For Δi>0 the flux transformer current discontinuously increases by Δi, and for Δi<0 it discontinuously decreases by Δi. The feedback current at B_{1 and B}₂ is discontinuously reduced to zero, and counter 18 registers a change of 1 Φ₀.

The flux transformer current discontinuity during the reset complicates crosstalk correction because the currents in between the discontinuities and current steps during the discontinuities have different crosstalk coefficients (or in other words, are related differently to the applied magnetic field). It can be shown from Equation (8) that the flux transformer current i can be made continuous if the various SQUID inductances and mutual inductances are selected to satisfy the following relationship:
MM_{F}=M_{TF}L_{S} (12)
If Equation (12) is satisfied, then the flux transformer current step Δi during the resets will be zero. In this case, even in digital systems, the flux transformer current i will vary smoothly and the crosstalk can be cancelled by a simple procedure which exploits Equation (4). Some embodiments of the invention provide SQUID sensors with digital feedback which are constructed so that Equation (12) is satisfied. In some situations, it may be sufficient if Equation (12) is satisfied only approximately.

It can be seen that one could vary the parameters of a SQUID system such that equation (12) is almost satisfied. For example, the inductances of a SQUID system may be adjusted such that:
|M_{F}M−M_{TF}Lₛ|≦Value (13)
where Value is selected to be sufficiently small such that the flux transformer current i will vary smoothly enough that crosstalk can be substantially cancelled by exploiting Equation (4). For example, Value may be selected to be 0.5 nH² (nanoHenries squared) or 0.1 nH².

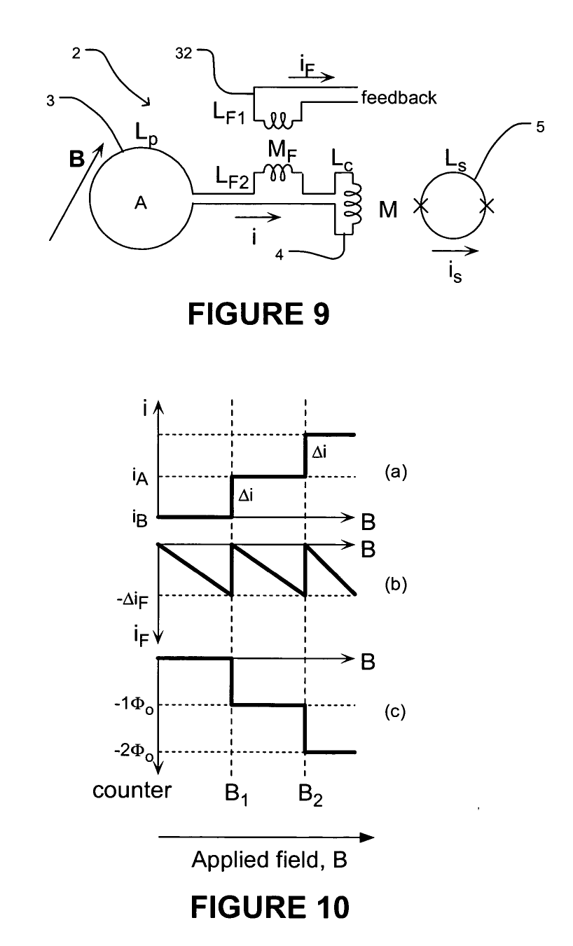

In multichannel SQUID systems made up of SQUID sensors 1 wherein the feedback signal is applied to flux transformer 2, such as the example illustrated in FIG. 6B, there is no crosstalk if the feedback signal is supplied by an analog feedback loop. However, if the feedback signal is supplied by a digital feedback loop (which provides an increased dynamic range, as discussed above), flux transformers 2 exhibit current discontinuities which in turn produce crosstalk between channels. FIG. 9 schematically illustrates various circuit parameters of such a SQUID sensor, the operation of which can be characterized by the following equations:
Φ_{fix}+BA=L_{FT}i+Miₛ+M_{F}i_{F} (14)
and
nΦ₀=Mi+Lₛiₛ (15)
wherein the various parameters represent the values described above with reference to Equations (6) and (7).

Equations (14) and (15) can be solved for flux transformer and feedback currents i and i_{F}, respectively. The changes of these currents during the SQUID reset, are obtained as:

$$\begin{matrix}Δ i = \frac{{Φ}_{0}}{M} \\ and & ( 16 ) \\ Δ {i}_{F} = \frac{{Φ}_{0}}{{L}_{s}} \frac{{L}_{FT} {L}_{s} - {M}^{2}}{{M}_{F} M} & ( 17 )\end{matrix}$$

FIG. 10 shows example graphs of flux transformer current i, feedback current i_{F}, and the counter value (18 in FIG. 2), which represents the digital component D of output signal S, versus applied field B, for a simplified example where the applied magnetic field is a linear ramp starting from B=0. At the reset, the feedback current i_{F} discontinuously changes to zero (similar to the situation when the feedback was supplied to the SQUID ring, as shown in FIG. 8). The flux transformer current i, however, behaves differently. It also exhibits a discontinuous jump at the reset, but in between the resets it is constant and will not contribute variable crosstalk (This is different from the situation when the feedback was supplied to SQUID ring 5—In that case, the flux transformer current i in between resets was increasing and was not constant, as shown in FIG. 8).

It is still possible to compensate for crosstalk even if the flux transformer current does not vary smoothly with applied field. This can be done by applying separate corrections for the digital and analog components of signals being detected by neighboring SQUID sensors. The output signal from a sensor which is part of a multi-channel SQUID system operated with a digital feedback loop, as described above, can be represented as follows:
Sₘ(t)=Aₘ(t)+Dₘ(t) (18)
where Sₘ(t) is the output from the m^{th} sensor; Aₘ(t) is the analog component of the output of the m^{th} sensor; and Dₘ(t) is the digital component of the output of the m^{th} sensor (see FIG. 4). The output signal S of the m^{th} sensor may also be expressed as:

$${S}_{m} ( t ) = {a}_{m} + {B}_{m} ( t ) + {\sum }_{j = 1 , j \neq m}^{M} {ξ}_{mj} [ {f}_{Dj} {D}_{j} ( t ) + {f}_{Aj} {A}_{j} ( t ) ] \qquad ( 19 )$$

where aₘ represents an unknown SQUID offset (and will be, without loss of generality, set to zero in subsequent equations by utilizing incremental quantities ΔS, ΔB, ΔD, and ΔA, instead of S, B, D, and A), f_{Aj} and f_{Dj} are fractions of the analog and digital signal components involved in the crosstalk, and the other parameters are as defined above.

If f_{A}≠f_{D}, then the net crosstalk coefficients for the analog and digital components are different and the analog and digital components will exhibit different crosstalk. The inventors have determined that the fractions f_{A} and f_{D} depend on the parameters of the SQUID system and the mutual inductance between adjacent and closely neighboring flux transformers. The fractions f_{A} and f_{D} may be computed from the geometries of the SQUID sensors 1 or may be measured experimentally.

The corrected output Bₘ(t) from a sensor may be represented in vector form either as:
ΔB=ζ^{D}ΔS+ψΔA (20)
or
ΔB=ζ^{A}S−ψΔD (21)
where ΔS, ΔB, ΔD and ΔA are vectors of incremental quantities with the number of components equal to the number of channels. The matrices ζ^{A}, ζ^{D} and ψ are given as:

$$\begin{matrix}{ζ}^{A} = ( \begin{matrix}1 & - {ξ}_{12} {f}_{A 2} & … & - {ξ}_{1 M} {f}_{AM} \\ - {ξ}_{21} {f}_{A 1} & 1 & … & - {ξ}_{2 M} {f}_{AM} \\ … & … & 1 & … \\ - {ξ}_{M 1} {f}_{A 1} & - {ξ}_{M 2} {f}_{A 2} & … & 1\end{matrix} ) & ( 22 ) \\ {ζ}^{D} = ( \begin{matrix}1 & - {ξ}_{12} {f}_{D 2} & … & - {ξ}_{1 M} {f}_{DM} \\ - {ξ}_{21} {f}_{D 1} & 1 & … & - {ξ}_{2 M} {f}_{DM} \\ … & … & 1 & … \\ - {ξ}_{M 1} {f}_{D 1} & - {ξ}_{M 2} {f}_{D 2} & … & 1\end{matrix} ) \\ and & ( 23 ) \\ ψ = ( \begin{matrix}0 & {ξ}_{12} ( {f}_{D 2} - {f}_{A 2} ) & … & {ξ}_{1 M} ( {f}_{D M} - {f}_{AM} ) \\ {ξ}_{21} ( {f}_{D 1} - {f}_{A 1} ) & 0 & … & {ξ}_{2 M} ( {f}_{D M} - {f}_{AM} ) \\ … & … & 0 & … \\ {ξ}_{M 1} ( {f}_{D 1} - {f}_{A 1} ) & {ξ}_{M 2} ( {f}_{D 2} - {f}_{A 2} ) & … & 0\end{matrix} ) & ( 24 )\end{matrix}$$

Using Equations 6, 7, 14 and 15 the fractions f_{A} and f_{D} may be computed for the two cases of feedback to the SQUID ring 5 and feedback to the flux transformer 2 (FIGS. 6A and 6B) as shown in

TABLE 1

| Feedback type | Fraction f_{A} | Fraction f_{D} |
|---|---|---|
| Feedback to SQUID ring | $\frac{{M}_{F}}{{L}_{s}} \frac{{L}_{FT} {L}_{s} - {M}^{2}}{{L}_{FT} {M}_{F} - {M}_{TF} M}$ | 1 |
| Feedback to flux transformer | 0 | 1 |

Where the SQUID sensors are constructed according to the rule in Equation (12), then it follows from Table 1 that for the case of “Feedback to SQUID ring” the fractions f_{A} and f_{D} satisfy f_{A}=f_{D}=1. Consequently, from Equations 5, 22, 23, and 24, it follows that ζ^{A}=ζ^{D}=ζ and ψ0, and from Equations 20 and 21 it follows that B=ζS. In other words, the crosstalk correction is greatly simplified and it is accomplished with only one matrix, as in for the analog system described above with reference to Equation 4.

Table 1 also indicates that for the case of “Feedback to flux transformer” (as described in Ter Brake et al. and shown in FIG. 6B), then only digital feedback is present (f_{A}=0). Consequently, from Equations 5, 22, 23, and 24, it follows that ζ^{A}=I, ζ^{D}=ζ and ψ=I−ζ, and from Equations 20 and 21 it follows that ΔB=ΔA+ζΔD. In other words, the analog component of the signal does not produce crosstalk; only the digital crosstalk must be corrected.

In order to correct for crosstalk using the methods described below one needs to have certain information including values for f_{A}, f_{D} and the values of the crosstalk coefficients ξᵢⱼ, or equivalent information. Such information can be obtained by computation or by measurement.

Computation of the fractions f_{A} and f_{D} can be performed from known parameters of SQUID sensors. Computation of the crosstalk coefficients ξᵢⱼ can be performed from the knowledge of the flux transformer geometry, distances between the flux transformers, and SQUID parameters. In practical situations such computations can be used if the crosstalk between channels is relatively small and correction to an accuracy of about 10% is adequate (it has been shown by comparison with experiment that computations can be carried out with such accuracy). In theory, calculations may be carried out to any desired degree of accuracy. In practice, deviations between designed and actual sensor geometries limit the accuracy with which the parameters for a specific sensor can be practically calculated.

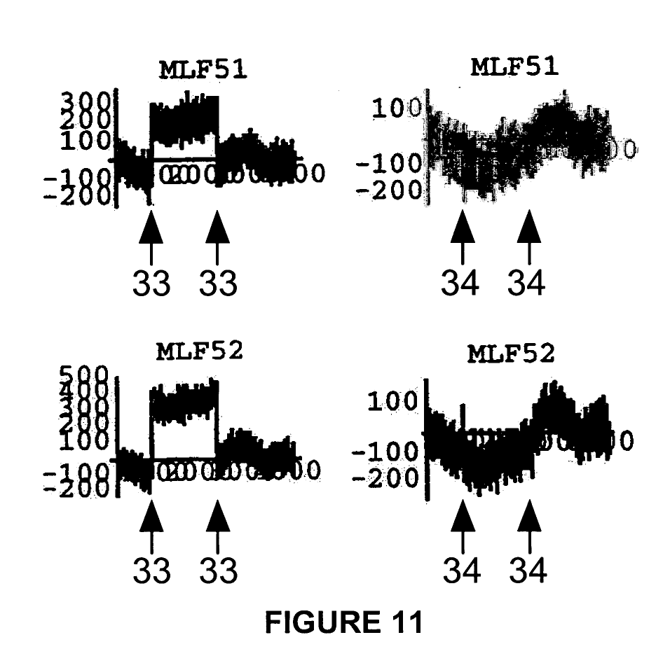

An example of crosstalk correction using values for f_{A}, f_{D} and ξᵢⱼ obtained by computation is shown in FIG. 11 for two different channels of an MEG system (channels MLF51 and MLF52). Arrows 33 indicate positions of digital crosstalk steps before correction and arrows 34 indicate the same locations in the data time trace, but after the crosstalk correction.

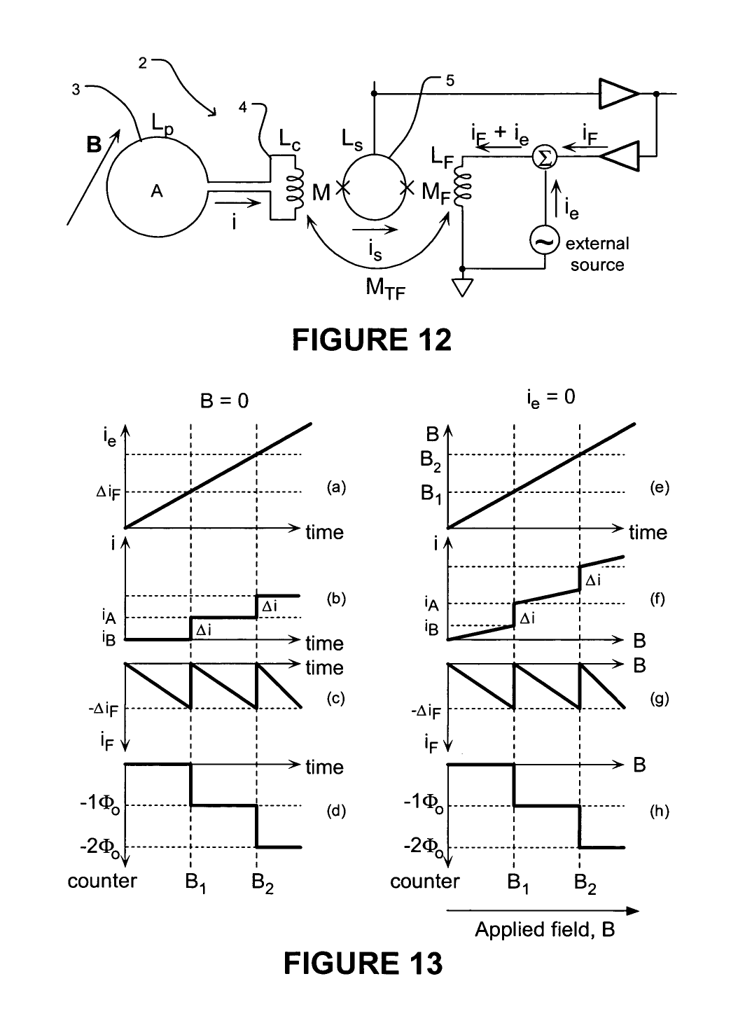

Measurement of crosstalk parameters can be performed by applying an external signal to one SQUID sensor so that the flux transformer of the one sensor carries a known current signal, and measuring the crosstalk signals received at each of the other SQUID sensors in the multi-channel system. The external signal can be applied directly to the SQUID feedback loop (for example, just before amplifier 10 in FIGS. 1 and 2). A schematic diagram of a SQUID circuit which permits injection of an external signal is shown in FIG. 12. In this case the system is characterized by the following equations:
Φ_{fix}+BA=L_{FT}i+Miₛ+M_{TF}(i_{F}+iₑ) (25)
and
nΦ₀=Mi+Lₛiₛ+M_{F}(i_{F}+iₑ) (26)
where iₑ is the current injected from the external source. As described above in relation to Equations (6), (7), (14) and (15), Equations (25) and (26) can be solved for the flux transformer current steps. The behavior of the currents and counter in the limit of either zero applied field (B=0), or zero applied current (iₑ=0), are shown in FIG. 13, in graphs (a)-(d) and (e)-(h), respectively. The flux transformer current i exhibits discontinuities in both cases. If the field B applied to flux transformer 2 is zero (only iₑ is varied), then the analog part of the current is constant and digital steps are the only manifestation of the crosstalk. If the current iₑ to the feedback loop is zero (only B is varied), then the behavior is the same as shown in FIG. 8 for feedback into the SQUID ring. In cases where the field applied to the flux transformer is kept zero (B=0), then Equations (25) and (26) can be solved for fractions f_{A} and f_{D} as:

$$\begin{matrix}{f}_{A} = 0 \\ and & ( 27 ) \\ {f}_{D} = \frac{M}{{L}_{s}} \frac{{M}_{F} M - {M}_{TF} {L}_{s}}{{L}_{FT} {M}_{F} - {M}_{TF} M} & ( 28 )\end{matrix}$$

Note that if the SQUID sensor was constructed by the special rule in Equation (12), then in the case of B=0, f_{A}=f_{D}=0 and there would be no crosstalk.

Crosstalk measurement by injecting current into the feedback loop (while there is no magnetic field applied to the flux transformer), as in FIG. 12, should preferably be performed in a magnetically quiet environment (e.g a shielded room). A known external signal (e.g. a sinusoidally varying signal) is applied to one SQUID sensor (as in FIG. 12). The known external signal is preferably strong enough to cause a SQUID output of at least several Φ₀ so that resets will occur in the source SQUID (the SQUID into which the external signal is injected). The known external signal preferably varies slowly so that a reasonably large number of data points can be collected between the resets. This will permit the accuracy of measurements to be improved by signal averaging. In this case all of the crosstalk detected at the other SQUID sensors comes from the digital component (because f_{A}=0). It can be shown in this case that the fraction f_{D} can be determined as a slope of a graph with the vertical axis representing the crosstalk signal divided by the reset field magnitude corresponding to 1 Φ₀, and the horizontal axis representing the computed value of the crosstalk coefficient (crosstalk coefficient computation assumes that the flux transformer geometry and the SQUID sensor parameters are well known). The results can be refined by repeating the calibration process using a different one of the SQUID sensors as the source and then combining the results obtained for the different source SQUID sensors.

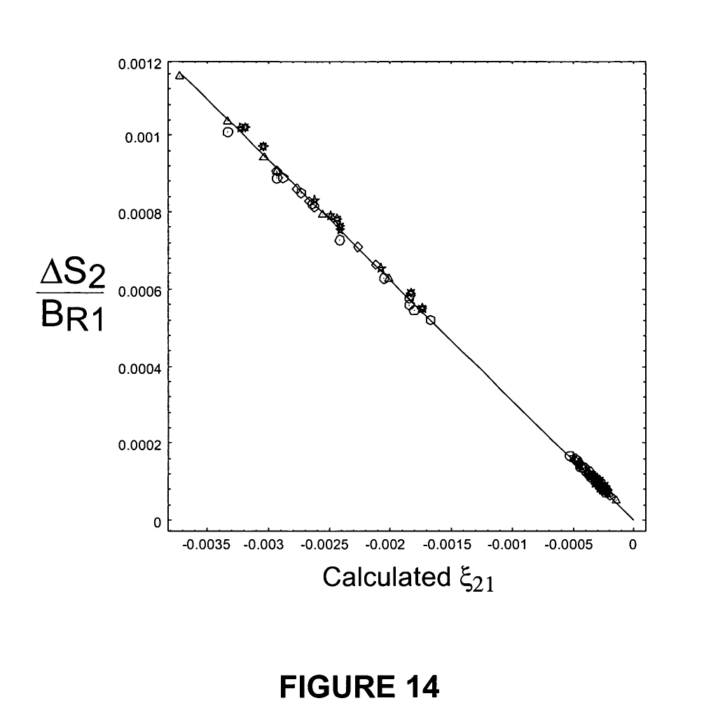

An example of such a graph for determination of f_{D} is shown in FIG. 14. Using nearest neighbor channels only, the digital fraction f_{D} can be determined with standard deviation of less than 1%. Results for several channels are shown in Table 2 below, where σ_{fD} denotes standard deviation of the determined fraction f_{D}.

TABLE 2

| Transmitting sensor | ƒ_{D} | σ_{ƒD} | σ_{ƒD} (%) |
|---|---|---|---|
| MLC14 | −0.3156 | 0.002 | 0.63 |
| MLC25 | −0.3192 | 0.0025 | 0.78 |
| MLC35 | −0.3129 | 0.0039 | 1.25 |
| MLP21 | −0.3101 | 0.0012 | 0.39 |
| MLP31 | −0.3033 | 0.002 | 0.66 |
| MLP41 | −0.3108 | 0.0018 | 0.58 |

When the experimentally determined digital fraction is compared with the computation as suggested above, the two methods can agree to better than 10%. For example, for a certain MEG system the digital fraction was computed as f_{D}=−0.347 and was measured as f_{D}=−0.354. Standard deviation of the differences between the computed and measured values was about 2%.

The discrete steps introduced by digital crosstalk contain high frequency components. In order to minimize filter transients associated with these steps it is desirable to eliminate the steps at a high sample rate before down sampling to the desired measurement sample rate. While it is possible to implement crosstalk correction during post processing it is preferable to do the correction in real time at the highest sample rate possible. The following describes such a system.

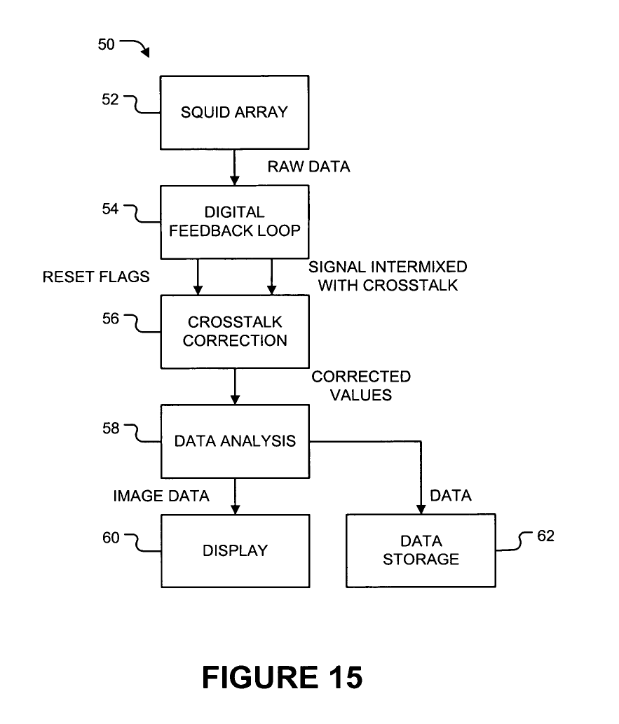

Some embodiments of this invention provide an apparatus which includes a plurality of SQUID sensors which each operate with feedback to a SQUID to yield an output signal having a discretely varying digital component and a smoothly varying analog component. For example, FIG. 15 shows a magnetic imaging system (such as a MEG or MRI system) 50 according to an embodiment of the invention. System 50 has an array 52 of SQUID sensors. The SQUID sensors produce raw data which is processed by a signal processing mechanism 54 (for example a digital feedback loop) to yield a stream of outputs with crosstalk intermixed with the true signal and a stream of reset flags containing information about the resets (e.g.—time, number of flux quantum shifts along the transfer function, and direction of the shifts).

The outputs together with the reset flags can be combined to separate the analog and digital components for the outputs of each sensor in SQUID array 52. In the alternative, the analog and digital components may be obtained directly from the SQUID electronics (e.g. for a SQUID sensor as shown in FIG. 2, the output of digital integrator 17 may be taken as the analog component and the value in counter 18 may be taken as the digital component). The analog and digital components pass through a crosstalk compensation stage 56 which determines corrected values for the outputs of each SQUID sensor in array 52.

Crosstalk compensation stage 56 may, for example, apply one of Equations (4), (20) or (21), or a mathematical equivalent thereof, to yield the output values corrected to remove crosstalk. The corrected values are provided to a data analysis mechanism which, for example, processes the corrected values to yield an MRI image or an MEG image. The image is displayed on a display 60 and data for the image is stored in a data store 62.

Since the amount of crosstalk between two SQUID sensors typically drops off rapidly with distance between the sensors, the computation of corrected output values for a particular SQUID sensor may be simplified by considering only contributions to crosstalk from other SQUID sensors which are “nearby” according to a suitable definition of nearby. For example, the term nearby may encompass: all nearest-neighbors; all nearest-neighbors and second-nearest-neighbors; all other SQUID sensors within a predetermined distance; all other SQUID sensors for which the values of ξᵢⱼ exceed a threshold; or the like.

Crosstalk among channels of a large multi-channel SQUID system will be discussed in the following sections. Each channel of such a multi-channel system will receive crosstalk from all other channels. For brevity, the channel receiving crosstalk will be called “receiving channel” (or receiving sensor) and the channels contributing crosstalk to a particular receiving channel will be called “source channels” (or source sensors).

Correcting both analog and digital crosstalk from a large number of source channels in real time and at a high sample rate for a large multi channel system can be computationally challenging. In some embodiments of crosstalk correction mechanism 56 a DSP (digital signal processor), configured fPGA (field programmable gate array), or ASIC (application specific integrated circuit) may be used as a computational device. In other embodiments a high-speed computer or computer cluster may be used. In all such embodiments, corrected values are determined by the computational device executing suitable software or hardware logic.

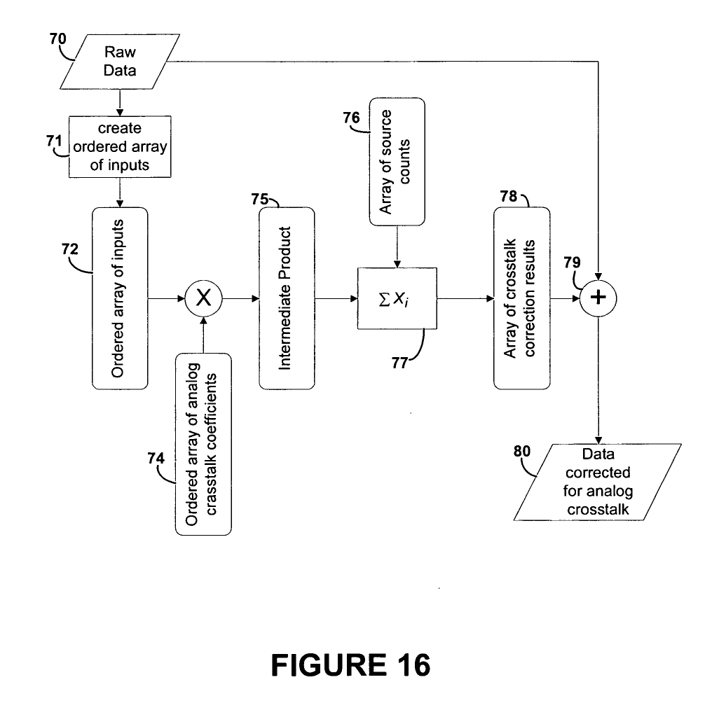

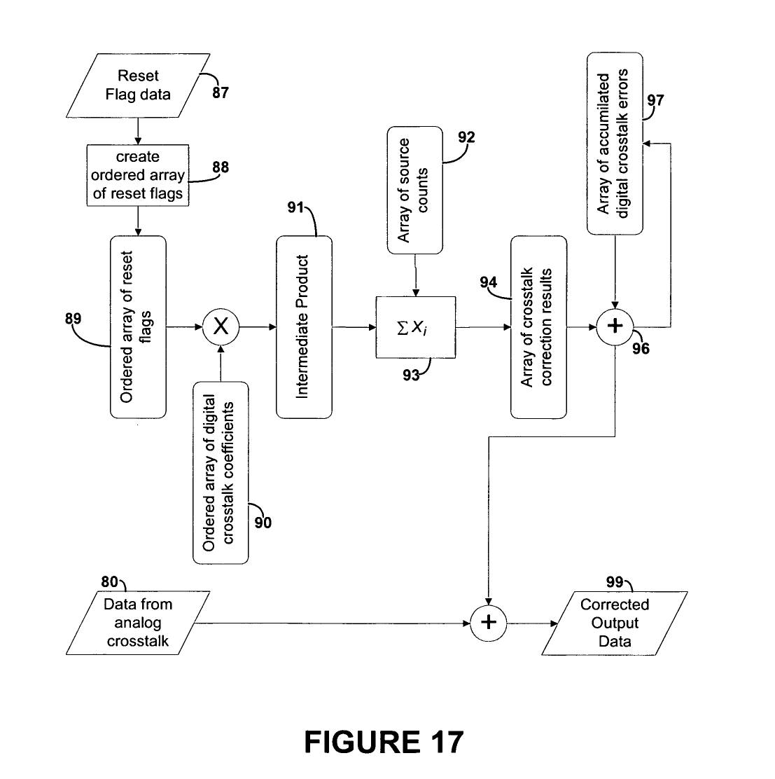

The following describes an embodiment of the invention utilizing a computing cluster. The design is capable of performing analog and digital crosstalk correction in real time at 12 kHz for 304 MEG channels. One node of the cluster performs analog crosstalk correction while a second node computes digital crosstalk correction. The nodes are connected through a high speed network that has sufficient bandwidth to prevent the network from becoming a processing bottleneck. The computers are 3.06 GHz Intel™ Xeon™ processors supporting the SSE2 command extensions (Streaming Single Instruction, Multiple Data). The SSE2 extensions permit two multiplications or additions of extended precision floating-point numbers per clock cycle so long as the data can be provided to the processor fast enough. In order to provide the data to the processor fast enough the data is prepared in such a way as to have corresponding elements of large arrays multiplied together. FIGS. 16 and 17 respectively show implementations of the analog and digital corrections that use data flows that can take advantage of the SSE2 commands.

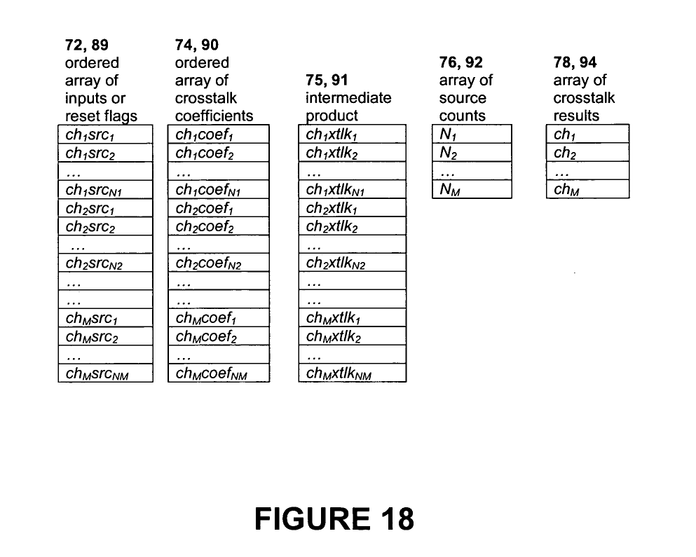

With respect to correction of the analog part of the crosstalk, as shown in FIG. 16, raw analog output data 70 from sensors is arranged in process 71 to form array 72. Array 72 contains a number of groups. Each group corresponds to one receiving channel and contains the SQUID output data for each source channel which may contribute crosstalk to the receiving channel. FIG. 18 shows a format of array 72 where chₘsrcₙ represents the n^{th} source channel contributing crosstalk to the receiving channel m, Nₘ is the number of source channels which contribute crosstalk to the receiving channel m and M represents the number of all receiving channels that are being corrected.

Utilizing the Intel SSE2 commands array 72 is multiplied by an array 74 which contains an ordered group of analog crosstalk coefficients to yield an array 75 of intermediate products. The analog crosstalk coefficients correspond to channels represented in the array 72 of the source channels. As shown in FIG. 18, arrays 74 and 75 may have a similar format to array 72.

In block 77 groups of values from the intermediate products in array 75 are summed together. The summation is shown symbolically by ΣXᵢ in block 77. To describe this summation in a greater detail, the following notation will be used:
Xₑ=chₘxtlkₙ is an element of array 75 (which is structurally similar to the arrays 72 and 74);
e is a sequential number of the element Xe;
n is an index corresponding to a source channel which contributes crosstalk to receiving channel m, n=1, 2, . . . , Nₘ; and,
m is a receiving channel index, m=1, 2, . . . , M, where M is the number of channels for which the crosstalk is being corrected.
The sequential numbers, e, are elements of the sequence:
e=1, . . . ,N₁,N₁+1, . . . ,N₁+N₂,N₁+N₂+1, . . . ,E (29)
where E is the number of elements in the arrays 72, 74, or 75 and is given by:

$$E = {\sum }_{m = 1}^{M} {N}_{m} \qquad ( 30 )$$

Summation of the crosstalk terms for each receiving channel in array 75 proceeds over indices e in the range from eₛₜₐᵣₜ to e_{end}. The ranges of e for each receiving channel m are shown in Table 3 below:

TABLE 3

| m | eₛₜₐᵣₜ | e_{end} |
|---|---|---|
| 1 | 1 | N₁ |
| 2 | 1 + N₁ | N₁ + N₂ |
| 3 | 1 + N₁ + N₂ | N₁ + N₂ + N₃ |
| . . . | . . . | . . . |
| m | $1 + {\sum }_{j = 1}^{m - 1} {N}_{j}$ | ${\sum }_{j = 1}^{m} {N}_{j}$ |
| . . . | . . . | . . . |
| M | $1 + {\sum }_{j = 1}^{M - 1} {N}_{j}$ | ${\sum }_{j = 1}^{M} {N}_{j} = E$ |

The summation can be done in the following sequence:
a. initialize the receiving channel m to m=1
b. get the corresponding value of array 76, i.e., Nₘ=N₁
c. set the summation range to (eₛₜₐᵣₜ)ₘ=(eₛₜₐᵣₜ)₁=1, and (e_{end})ₘ=(e_{end})₁=N₁.
d. sum the crosstalk contributions to channel m=1 as

$${\sum }_{{( e = {e}_{start} )}_{1}}^{{( {e}_{end} )}_{1}} {X}_{e} = {\sum }_{n = 1}^{{N}_{m}} {ch}_{1} {xtlk}_{n} \qquad ( 31 )$$
e. increase the channel index m by 1
f. select the next value of array 76, corresponding to m, i.e., Nm
g. set the summation range to (eₛₜₐᵣₜ)ₘ and (e_{end})ₘ
h. sum the crosstalk contribution to channel m as

$${\sum }_{e = {e}_{start}}^{{e}_{end}} {X}_{e} = {\sum }_{n = 1}^{{N}_{m}} {ch}_{m} {xtlk}_{n} \qquad ( 32 )$$
i. repeat steps e to h until m=M.
   The results, in array 78, are then added to the raw SQUID output data as indicated at 79 to yield analog corrected data 80. FIG. 18 shows the format of arrays 76 and 78.

As shown in FIG. 17, corrections for the contribution to crosstalk of the digital component of the sensor signals may be made in a similar manner. Reset flag data 87 from the digital SQUID feedback loop (element 25 in FIG. 2) is ordered in process 88 into a specially structured array of reset flags 89. Each reset flag may have one of three values −1, 0 or 1. These values correspond respectively to: a negative transitioning reset (decrease of the number of flux quanta in SQUID ring 5), no reset, or positive transitioning reset (increase of the number of flux quanta in SQUID ring 5). The reset flags are multiplied by an array 90 of digital crosstalk coefficients to yield an intermediate product array 91.

In block 93, each group of intermediate products within array 91 is summed as described above with respect to correction of the analog part of the crosstalk. The result, array 94, is summed at point 96 to an accumulated digital crosstalk array 97. Array 97 acts as an accumulator, and contains the accumulated digital reset contributions for each channel receiving a crosstalk signal. Accumulator 97 is zeroed at the start of a data collection. The results in accumulator 97 are added to the data already corrected for the analog crosstalk 80 to yield fully corrected sensor data 99. As shown in FIG. 18 the format of arrays 89, 90, 91, 92 and 94 are similar to those of arrays 72, 74, 75, 76 and 78 in FIG. 16 used in the analog crosstalk correction process. An alternative to accumulation at the end of the process is to accumulate resets at the beginning of the process, between reset flag data 87 and process 88.

Certain implementations of the invention comprise computer processors which execute software instructions which cause the processors to perform a method of the invention. For example, one or more processors in a magnetic imaging system may implement data processing steps in the methods described herein by executing software instructions retrieved from a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
In the foregoing description, the feedback system is reset each time the flux in the SQUID changes by ±1 Φ₀. It is beneficial in some embodiments to reset the feedback system only when the flux in the SQUID changes by some other number of flux quanta, i.e., ±½Φ₀ or ±nΦ₀, where n>1. Methodology similar to that described here also applies to the configuration when feedback is supplied to the flux transformer, provided the correct values of the crosstalk fractions f_{A} and f_{D} are used (see Table 1).
In some embodiments of the invention f_{A}<<f_{D} and sufficient crosstalk correction can be achieved by correcting only for the digital part of the crosstalk. In such cases, and particularly if the crosstalk is small, crosstalk correction may be approximated by inserting f_{A}≈0 into Equations 20 and 21.
In some embodiments of the invention Equation (12) is satisfied only approximately. In such embodiments, the two products on either side of Equation (12) are considered to be “substantially equal” if their respective values are within about 10% of each other, or for a particular SQUID design, within about 0.5 nH² or 0.1 nH².
   Accordingly, the scope of the invention is to be construed in accordance with the substance defined by the following claims.

What is claimed is:

1. A method of compensating for crosstalk between electromagnetic sensors in a sensor array, each sensor having a flux transformer with a current therein which does not vary smoothly with an applied magnetic field, each sensor configured to produce an output signal comprising a stepwise varying component and a finely varying component, the method comprising:
for each sensor to be compensated, applying a crosstalk compensation function to the output signal of the sensor to be compensated, the crosstalk compensation function based at least in part on at least one of the stepwise and the finely varying components of at least one other of the sensors in the array.

2. A method according to claim 1 wherein the crosstalk compensation function is based at least in part on a linear combination of the stepwise varying components of the output signals of a plurality of other sensors in the array.

3. A method according to claim 1 wherein the crosstalk compensation function is based at least in part on a linear combination of the finely varying components of the output signals of a plurality of other sensors in the array.

4. A method according to claim 1 wherein the crosstalk compensation function is based at least in part on a linear combination of the output signals of a plurality of other sensors in the array.

5. A method according to claim 1 wherein the stepwise varying component of the output signal of each sensor comprises one of a plurality of predetermined values, each of the plurality of predetermined values being separated by a predetermined amount.

6. A method according to claim 1 wherein each of the sensors in the array comprises a SQUID inductively coupled to the flux transformer, the method comprising:
providing a feedback signal to the SQUID to cancel magnetic flux in the SQUID;
resetting the feedback signal when the feedback signal is cancelling a predetermined number of flux quanta; and,
counting a number of resets of the feedback signal, and wherein the crosstalk compensation function is based at least in part on both the stepwise and the finely varying components of at least one other of the sensors in the array.

7. A method according to claim 6 wherein the crosstalk compensation function is based at least in part on a linear combination of the stepwise varying components of the output signals of a plurality of other sensors in the array.

8. A method according to claim 6 wherein the crosstalk compensation function is based at least in part on a linear combination of the finely varying components of the output signals of a plurality of other sensors in the array.

9. A method according to claim 6 wherein the crosstalk compensation function is based at least in part on a linear combination of the output signals of a plurality of other sensors in the array.

10. A method according to claim 6 wherein the stepwise varying component of the output signal of each sensor comprises one of a plurality of predetermined values, each of the plurality of predetermined values being separated by a value equivalent to an integer multiple of one half of a flux quantum (½Φ₀) or an integer multiple of Φ₀.

11. A method according to claim 1 comprising:
providing a feedback signal to the flux transformer of each sensor to cancel current therein;
resetting the feedback signal when the feedback signal is cancelling a predetermined amount of current; and,
counting a number of resets of the feedback signal, and wherein the crosstalk compensation function is based on the stepwise varying components of at least one other of the sensors in the array.

12. A method according to claim 11 wherein the crosstalk compensation function is based on a linear combination of the stepwise varying components of the output signals of a plurality of other sensors in the array.

13. A method according to claim 11 wherein the stepwise varying component of the output signal of each sensor comprises one of a plurality of predetermined values, each of the plurality of predetermined values being separated by a predetermined amount.

14. A method according to claim 1 comprising:
obtaining a stepwise crosstalk correction fraction for each sensor;
wherein the crosstalk compensation function is based at least in part on the stepwise crosstalk correction fractions of the at least one other of the sensors.

15. A method according to claim 14 wherein obtaining the stepwise crosstalk correction fraction for each sensor comprises calculating the stepwise crosstalk correction fraction for each sensor based on known parameters of the sensor.

16. A method according to claim 14 wherein obtaining the stepwise crosstalk correction fraction for each sensor comprises calibrating the sensor by applying an external signal to the at least one other of the sensors in the array and measuring a signal produced by the sensor in response to the application of the external signal to the at least one other of the sensors.

17. A method according to claim 1 comprising:
obtaining a fine crosstalk correction fraction for each sensor;
wherein the crosstalk compensation function is based at least in part on the fine crosstalk correction fractions of the at least one other of the sensors.

18. A method according to claim 17 wherein obtaining the fine crosstalk correction fraction for each sensor comprises calculating the fine crosstalk correction fraction for each sensor based on known parameters of the sensor.

19. A method according to claim 17 wherein obtaining the fine crosstalk correction fraction for each sensor comprises calibrating the sensor by applying an external signal to the at least one other of the sensors in the array and measuring a signal produced by the sensor in response to the application of the external signal to the at least one other of the sensors.

20. A method according to claim 1 comprising:
determining a stepwise crosstalk correction fraction for each sensor; and,
determining a fine crosstalk correction fraction for each sensor,
wherein, when the fine crosstalk correction fraction for a sensor is less than a predetermined threshold and is also less than about 1% of the stepwise crosstalk correction fraction of that sensor, the crosstalk correction function disregards the fine correction fraction and the finely varying component of the output signal of that sensor.

21. A method according to claim 1 wherein the at least one other sensor in the array comprises a set of sensors chosen according to contribution to a crosstalk error signal in the sensor to be compensated.

22. A method according to claim 21 wherein the set of sensors comprise every sensor within a predetermined distance of the sensor to be compensated.

23. A method according to claim 21 wherein the set of sensors comprise every sensor having a crosstalk coefficient larger than a predetermined threshold.

24. A method according to claim 21 wherein the set of sensors comprise every sensor which induces a digital step larger than a predetermined threshold in the sensor to be compensated.

25. A method according to claim 21 wherein the set of sensors comprise every sensor having a stepwise crosstalk correction fraction above a predetermined threshold.

26. A method according to claim 21 wherein the set of sensors comprise every sensor having a fine crosstalk correction fraction above a predetermined threshold.

27. A method according to claim 1 wherein each sensor comprises a SQUID inductively coupled to a flux transformer coupling coil and a feedback coil, wherein, for at least some of the sensors, a first product of a mutual inductance between the flux transformer coupling coil and the SQUID and a mutual inductance between the feedback coil and the SQUID is substantially equal to a second product of a mutual inductance between the feedback coil and the flux transformer coupling coil and an inductance of the SQUID.

28. A method according to claim 1 comprising creating an ordered array of inputs from the output signals and multiplying the ordered array of inputs by an ordered array of analog crosstalk coefficients to generate an array of analog intermediate products.

29. A method according to claim 28 comprising summing the array of analog intermediate products for each sensor to be compensated to generate an array of analog crosstalk correction results.

30. A method according to claim 29 comprising adding the array of analog crosstalk correction results to the output signals to generate analog crosstalk corrected data.

31. A method according to claim 30 comprising creating an ordered array of digital inputs from the stepwise varying components of the output signals and multiplying the ordered array of digital inputs by an ordered array of digital crosstalk coefficients to generate an array of digital intermediate products.

32. A method according to claim 31 comprising summing the array of digital intermediate products for each sensor to be compensated to generate an array of digital crosstalk correction results.

33. A method according to claim 32 comprising accumulating values of the array of digital crosstalk correction results over a data collection period to generate an accumulated array of digital crosstalk correction results.

34. A method according to claim 33 comprising summing the accumulated array of digital crosstalk correction results with the analog crosstalk corrected data to generate corrected output data.

35. A method according to claim 1 comprising:
creating an ordered array of digital inputs from the stepwise varying components of the output signals and multiplying the ordered array of digital inputs by an ordered array of digital crosstalk coefficients to generate an array of digital intermediate products;
summing the array of digital intermediate products for each sensor to be compensated to generate an array of digital crosstalk correction results;
accumulating values of the array of digital crosstalk correction results over a data collection period to generate an accumulated array of digital crosstalk correction results; and
summing the accumulated array of digital crosstalk correction results with the output signals to generate digital crosstalk corrected data.

36. A method according to claim 35 comprising:
creating an ordered array of analog inputs from the finely varying components of the output signals and multiplying the ordered array of analog inputs by an ordered array of analog crosstalk coefficients to generate an array of analog intermediate products;
summing the array of analog intermediate products for each sensor to be compensated to generate an array of analog crosstalk correction results; and,
summing the array of analog crosstalk correction results with the digital crosstalk corrected data to generate corrected output data.

37. A method according to claim 1 comprising:
accumulating values of digital inputs from the stepwise varying components of the output signals over a data collection period to generate an ordered array of stepwise data;
multiplying the ordered array of stepwise data by an ordered array of digital crosstalk coefficients to generate an array of digital intermediate products;
summing the array of digital intermediate products for each sensor to be compensated to generate an array of digital crosstalk correction results; and
summing the array of digital crosstalk correction results with the output signals to generate digital crosstalk corrected data.

38. A method according to claim 37 comprising:
creating an ordered array of analog inputs from the finely varying components of the output signals and multiplying the ordered array of analog inputs by an ordered array of analog crosstalk coefficients to generate an array of analog intermediate products;
summing the array of analog intermediate products for each sensor to be compensated to generate an array of analog crosstalk correction results; and,
summing the array of analog crosstalk correction results with the digital crosstalk corrected data to generate corrected output data.

39. A method according to claim 1 comprising:
creating an ordered array of inputs from the output signals and multiplying the ordered array of inputs by an ordered array of analog crosstalk coefficients to generate an array of analog intermediate products;
summing the array of analog intermediate products for each sensor to be compensated to generate an array of analog crosstalk correction results; and,
summing the array of analog crosstalk correction results with the output to generate analog crosstalk corrected data.

40. A method according to claim 39 comprising:
accumulating values of digital inputs from the stepwise varying components of the output signals over a data collection period to generate an ordered array of stepwise data;
multiplying the ordered array of stepwise data by an ordered array of digital crosstalk coefficients to generate an array of digital intermediate products;
summing the array of digital intermediate products for each sensor to be compensated to generate an array of digital crosstalk correction results; and
summing the array of digital crosstalk correction results with the analog crosstalk corrected data to generate corrected output data.

41. A method of compensating for crosstalk between electromagnetic sensors in an array of electromagnetic sensors, each of the sensors having a flux transformer carrying an electrical current which does not vary smoothly with an applied magnetic field, each sensor configured to produce an output signal comprising a stepwise varying component and a finely varying component, the method comprising, for each sensor to be compensated:
determining a stepwise crosstalk correction fraction for the sensor to be compensated;
providing the stepwise crosstalk correction fraction to a first plurality of sensors in the array;
receiving stepwise crosstalk correction fractions from a second plurality of sensors in the array;
for each of the second plurality of sensors:
determining a crosstalk factor between the one of the second plurality of sensors and the sensor to be compensated; and,
multiplying the crosstalk factor by the stepwise crosstalk correction fraction received from the one of the second plurality of sensors to determine a stepwise product; and,
compensating for crosstalk received by the sensor to be compensated from the second plurality of sensors by applying a crosstalk compensation function to the output signal of the sensor to be compensated, the crosstalk compensation function based at least in part on the stepwise products.

42. A method according to claim 41 wherein each of the sensors in the array comprises a SQUID inductively coupled to the flux transformer, the method comprising:
providing a feedback signal to the SQUID to cancel magnetic flux through the SQUID from the flux transformer;
resetting the feedback signal when the feedback signal is cancelling a predetermined number or flux quanta; and,
counting a number of resets of the feedback signal;
wherein the stepwise varying component of the output signal of each sensor is determined by the predetermined number of flux quanta and the number of resets.

43. A method according to claim 42 wherein the finely varying component of the output signal of each sensor is determined by a change in the feedback signal since a most recent reset, the method comprising, for each sensor to be compensated:
determining a fine crosstalk correction fraction for the sensor to be compensated;
providing the fine crosstalk correction fraction to the first plurality of sensors in the array;
receiving fine crosstalk correction fractions from the second plurality of sensors in the array; and,
for each of the second plurality of sensors, multiplying the crosstalk factor by the fine crosstalk correction fraction received from the one of the second plurality of sensors to determine a fine product,
wherein the crosstalk compensation function is also based at least in part on the fine products.

44. An apparatus comprising a sensor array for measuring magnetic fields, the sensor array comprising a plurality of sensors, each sensor comprising a SQUID inductively coupled to a flux transformer coupling coil and a feedback coil, wherein a first product of a mutual inductance between the flux transformer coupling coil and the SQUID and a mutual inductance between the feedback coil and the SQUID is substantially equal to a second product of a mutual inductance between the feedback coil and the flux transformer coupling coil and an inductance of the SQUID.

45. An apparatus comprising a sensor array for measuring magnetic fields, the sensor array comprising a plurality of sensors, each sensor comprising a SQUID inductively coupled to a flux transformer coupling coil and a feedback coil, wherein a difference between:
a first product of a mutual inductance between the flux transformer coupling coil and the SQUID and a mutual inductance between the feedback coil and the SQUID; and,
a second product of a mutual inductance between the feedback coil and the flux transformer coupling coil and an inductance of the SQUID is less than 0.5 nH².

46. An apparatus according to claim 45 wherein the difference is less than 0.1 nH².

47. An apparatus for compensating for crosstalk between electromagnetic sensors in an array, each sensor having a flux transformer with a current therein which does not vary smoothly with an applied magnetic field, each sensor configured to produce an output signal comprising a stepwise varying component and a finely varying component, the apparatus comprising:
means for applying a crosstalk compensation function to the output signal of each sensor to be compensated, the crosstalk compensation function based at least in part on at least one of the stepwise and the finely varying components of at least one other of the sensors in the array.

48. A computer program product comprising a medium carrying computer readable instructions which, when executed by a processor, cause the processor to execute a method of compensating for crosstalk between electromagnetic sensors in an array, each sensor having a flux transformer with a current therein which does not vary smoothly with an applied magnetic field, each sensor configured to produce an output signal comprising a stepwise varying component and a finely varying component, the method comprising:
for each sensor to be compensated, applying a crosstalk compensation function to the output signal of the sensor to be compensated, the crosstalk compensation function based at least in part on at least one of the stepwise and the finely varying components of at least one other of the sensors in the array.
